(19) United States
(12) Patent Application Publication
(10) Pub. No.: US 2012/0024633 A1
(43) Pub. Date: Feb. 2, 2012

(54) Gyromotor

(76) Inventor: John M. Vranish, Crofton, MD (US)

(21) Appl. No.: 13/135,932

(22) Filed: Jul. 19, 2011

Related U.S. Application Data
(60) Provisional application No. 61/400,613, filed on Jul. 30, 2010.

(51) Int. Cl. F03G 3/08

(52) U.S. Cl. 185/29

(57) ABSTRACT

Gyromotor is a type of action and reaction motor which generates thrust without plume ejection. Whereas rockets react equal and opposite to ejected mass momentum, Gyromotor cycles gyroscopes, each mounted on the end of a moment arm, in a back and forth rowing motion to drive a spacecraft, without external mass ejection analogous to rowing a boat. Gyroscope inertial properties are configured to provide maximum resistance torque during the drive stroke and reconfigured to provide minimum torque resistance during the return stroke. The gyroscopes are turned by a moment arm so the torque resistance provides a useful linear pseudo force component to drive the spacecraft, with said linear force greater during the drive stroke than the return stroke, analogous to an oar in water during the drive stroke and in air during the return stroke. The space craft moves in reaction to the net linear pseudo forces and momentum is conserved. The pseudo forces are caused by the change of direction of each gyroscope spin axis during its moment arm rotation, similar to centripetal and coriolis effect, pseudo forces.

The U.S. patent application claims the priority of U.S. Provisional Application No. 61/400,613 filed on Jul. 30, 2010.

### ORIGIN OF THE INVENTION

The invention was made by John M. Vranish as President of Vranish Innovative Technologies LLC and may be used by John M. Vranish and Vranish Innovative Technologies LLC without the payment of any royalties therein or therefore. The work was done by John M. Vranish on his own time and at his own expense.

### BACKGROUND OF THE INVENTION

There is a large and growing presence of objects in earth orbit associated with human activity. There is need to maneuver these objects and to have ready access to them and this requires a practical transportation system that works in earth orbit where vacuum and micro gravity conditions prevail. This, in turn, suggests an action and reaction motor is required that runs on renewable energy.

Rockets are the means currently employed and these are severely limited in their usefulness. The prime means of earth orbit maneuver is hydrazine rocket motors, a World War 2 era propulsion technique that powered the Me 163. Komet. Hydrazine rockets run out of fuel, are corrosive and volatile and lack capability for precision control. Ion engines are emerging as a more modern alternative, but, these also run out of fuel. Ion engines, in their present stage of development, are too low in thrust for practical earth orbit operations because activities would take too long.

A propulsion means is needed that provides a safe, useful level of thrust and that runs on renewable energy without emitting a plume. Three (3) approaches were tried with three different approaches to the physics of propulsion and all three are in different stages of development. Gyromotor is the latest evolution of one of these approaches and has reached the point where it needs patent protection. Any plume-less action and reaction motor is subject to skepticism and controversy and Gyromotor is no exception. The skeptics worry that inertial activities confined to a closed system cannot affect activities outside said closed system. John M. Vranish respects these arguments, takes them seriously and addresses them in the specification of this patent application. Experiment will settle the issue. In the mean time this patent application establishes the origin of the John M. Vranish Gyromotor concept.

### FIELD OF THE INVENTION

The present invention relates generally to action and reaction propulsion motors and more particularly to action and reaction propulsion systems that utilize gyroscopes. The present invention relates generally to gyroscope systems and more particularly to gyroscope systems used in propulsion applications. The present invention relates particularly to electromechanical and motion control systems.

### DESCRIPTION OF THE PRIOR ART

1. Hydrazine rockets are currently used in earth orbit space operations and have been so for many years. These are chemical action and reaction engines that emit plumes and provide linear motion. As a practical matter, hydrazine is hard to resupply in space and is non-renewable.
2. Ion Engines are being developed but, are not yet in extensive use. These are electromagnetic action and reaction engines that emit plumes and provide linear motion. As a practical matter, the ions in the plume are also non-renewable in space. Ion Thrusters are being pursued in many forms.
   a. Electrostatic
   b. Electromagnetic Lorentz Force
   c. Hall Effect
3. CGM (Control Gyroscope Moment) systems use gyroscopes for attitude control (Single Gimble, Dual Gimble, Variable Speed). These are action and reaction motors that do their rotation work without emitting a plume but, cannot provide linear motion. They can be supplied in space using electrical energy from the sun via solar panel.
4. There have been attempts to use gyroscopes to provide both rotary and linear motion without emitting a plume.
   a. The Generation of a Unidirectional Force [Bruce E. DePalma—Simularity Institute 1974] “The mechanical generation of a unidirectional force, is shown to be a consequence of the variable inertial property of matter.” (Gyroscopes are used.) [prior art]
   b. John M. Vranish Abandoned patent application [prior art]. This reached the Preliminary application stage before it went abandoned.

### SUMMARY OF THE INVENTION

Gyromotor is a type of action and reaction motor which generates thrust without plume ejection. Whereas rockets react equal and opposite to ejected mass momentum, Gyromotor cycles gyroscopes, each mounted on the end of a moment arm, in a back and forth rowing motion to drive a spacecraft, without external mass ejection analogous to rowing a boat. Gyroscope inertial properties are configured to provide maximum resistance torque during the drive stroke and reconfigured to provide minimum torque resistance during the return stroke. The gyroscopes are turned by a moment arm so the torque resistance provides a useful linear force component to drive the spacecraft, with said linear force greater during the drive stroke than the return stroke, analogous to an oar in water during the drive stroke and in air during the return stroke. The space craft moves in reaction to the net linear forces and momentum is conserved. The torques and forces are pseudo and are generated by change of gyroscope spin axis during said moment arm rotation, similar to centrifugal and coriolis effect pseudo forces. The Gyromotor Invention will provide maximum resistance torque and resistance linear force during the Drive Stroke because the gyroscopes are each spinning and are oriented such that the spin axis of each is perpendicular to the axis of moment arm rotation. Maximum net action and reaction force, then depends on minimizing resistance torque and linear reaction force during the return stroke.

Two (2) methods of reconfiguring the gyroscopes to provide minimum torque and linear force during the return stroke are considered. In one method, the spin of each gyroscope is reduced to zero, prior to the Return Stroke, so gyroscope orientation doesn't matter. In an alternate method, the spin axis of each gyroscope is redirected prior to the Return Stroke such that each is parallel to the angular direction of rotation. Thus, there is no change in direction of gyroscope spin during return, with no gyroscope torque resistance and no reactive linear force even though the gyroscopes are spinning.

Electro-mechanical devices and systems essential to performing the Gyromotor functions are described. These include a system for rotating said moment arms, a system for spinning gyroscopes, a system for cancelling gyroscope precession in the preferred embodiment and a method for cancelling the effects of changing the orientation of each spinning gyroscope in said alternate method. Also included in this description are representative form, fit and function numbers to provide expected performance information and construction and operating particulars needed to achieve said performance.

### BRIEF DESCRIPTION OF THE DRAWINGS

A more complete appreciation of the invention and man of its attendant advantages will be readily appreciated as the same becomes better understood by reference to the following detailed description when considered in connection with the accompanying drawings wherein:

FIGS. 1a and 1b illustrate the base components of a Gyromotor and show how said base components move during said Gyromotor drive and return strokes: FIGS. 1a and 1b also show the inertial reaction force difference between said drive stroke and said return stroke.

FIGS. 2a and 2b show how a pair of spinning gyroscopes, on the end of a turning moment arm, creates an inertial reaction force with a linear component useful for powering a vehicle. FIG. 2a shows how said inertial reaction force is physically created by using a turning moment arm to turn said pair of spinning gyroscopes affixed to end of said moment arm. FIG. 2b interprets the actions and results of FIG. 2a as a lever arm functionally equivalent diagram.

FIG. 3a details how Gyromotor applies directional inertial force to said vehicle during said Drive Stroke and FIG. 3 b details how the Gyromotor removes said directional inertial force during said Return Stroke.

FIG. 4 shows how gyroscopes can be configured in pairs to cancel precession, while adding said directional inertial force of each.

FIG. 5a illustrates a configuration whereby a motor gear drive can operate through an idler gear to rotate said gyroscopes on the end of a moment arm. FIG. 5b illustrates an alternate configuration whereby said motor gear drive can operate through an idler gear to rotate said gyroscopes on the end of a moment arm.

FIG. 6a illustrates a configuration whereby idler gears can be configured in coaxial pairs to independently spin the gyroscope pairs and rotate the moment arm on which the gyroscopes are mounted from a top view perspective. FIG. 6b illustrates the configuration introduced in FIG. 6a from a side section view perspective.

FIG. 7 illustrates a configuration whereby one pair of motor gear drives can operate on a pair of idler gear arrangements, according to FIG. 6a, to provide and control gyroscope spin, while a second pair of motor gear drives can operate on a second pair of idler gear arrangements, to provide and control moment arm rotation also according to FIG. 6a, with gyroscope spin and moment arm rotation functions independent.

FIG. 8a illustrates the Alternate Drive Cycle Drive Stroke wherein said directions of gyroscope spin are oriented to maximize inertial drive force on said vehicle. FIG. 8b illustrates said Alternate Drive Cycle Return Stroke wherein said directions of gyroscope spin are re-oriented to minimize inertial drive force on said vehicle.

FIG. 9a illustrates the inertial torque reacted to said vehicle by changing the spin direction of said gyroscopes at the end of said Alternate Drive Cycle Drive Stroke, preparatory to said Alternate Drive Cycle Return Stroke. FIG. 9b illustrates the inertial torque reacted to said vehicle by changing the spin direction of said gyroscopes at the end of said Alternate Drive Cycle Return Stroke, preparatory to said Alternate Drive Cycle Drive Stroke. FIG. 9a and FIG. 9b together show the net torque reacted to said vehicle by changing spin direction to be zero over each complete Alternate Drive and Return Cycle.

FIG. 10a Illustrates the mechanical parts used to perform said Alternate Drive Cycle Stroke and their arrangement. A top down section view of said mechanical parts is presented in the region where they interface with said gyroscope pair.

FIG. 10b Illustrates said mechanical parts used to perform said Alternate Drive Cycle Stroke and their arrangement. A side section view of said mechanical parts is presented in the region where they interface with said gyroscope pair.

FIG. 11 Illustrates said mechanical parts used to perform said Alternate Drive Cycle Stroke and their arrangement. A side section view is presented in the region where they interface with said Motor Gear Drives.

### DETAILED DESCRIPTION OF PREFERRED EMBODIMENT

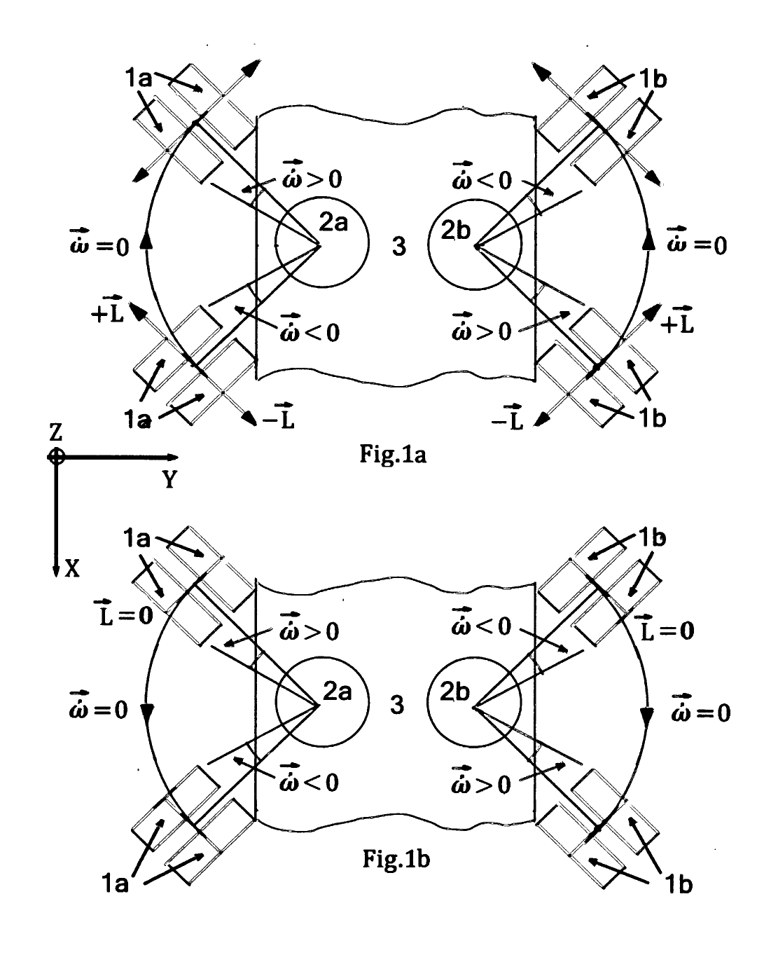

In accordance with the present invention, a Gyromotor includes: 1. a Gyroscope Arm System, 2. A Motor Control System to control and motivate said Gyroscope Arm System, 3. a Housing for 1 and 2. The Gyroscope Arm System includes a Left Arm System and a Right Arm System n which each of the two arm systems contains a pair of co-axial gyroscopes mounted on the end of a moment arm. The Motor Control System includes a Left Motor Control System and a Right Motor Control System. The Left Motor Control System rotates the Left Moment Arm and attached gyroscopes and, independently, spins the Left Arm System gyroscopes at angular velocities equal and opposite to each other. The Right Motor Control System rotates the Right Moment Arm and attached gyroscopes and, independently, spins the Right Arm System gyroscopes at angular velocities equal and opposite to each other. For linear travel, the Left and Right Arm Systems are rotated towards and away from each other in a coordinated back and forth rowing motion. The gyroscopes are spinning during the Drive Stroke and are not spinning during the Return Stroke, with the spin axis of each gyroscope oriented perpendicular to the axis of its moment arm rotation. The Left Motor Control System contains a motor and gear system and controller and the Right Motor Control System contains a mirror image motor and gear system and controller. The Housing contains said Gyroscope Arm and Motor Control Systems. The preferred embodiment is configured and operated according to FIGS. 1a and 1b.

### I. GYROMOTOR DRIVE METHOD (FIGS. 1a, 1b)

Two (2) moment arms are counter-rotated back and forth in opposition to each other in a cyclic manner as per FIGS. 1a, 1b. Each moment arm has two (2) gyroscopes mounted on its end with the spin axis of each oriented in the direction of gyroscope instantaneous velocity. Normally this would produce no net motion as per the Zero-Sum nature of Newton's Laws of Motion. It would move in the +X direction during the Drive Stroke and return the same amount in the −X direction during the return stroke. But the gyroscopes during the Drive Stroke are at full spin during the Drive Stroke and are without spin during the Return Stroke and this difference in gyroscopic spin upsets Zero-Sum in favor of the Drive Stroke. We will now show why this is so.

### A. Drive Stroke

During the Drive Stroke, the gyroscopes are spinning and oriented as shown in FIG. 1a. The gyroscope pair attached to the left moment arm is labeled 1a and is rotated on the end of the left moment arm by a motor and gear system labeled 2a. The gyroscope pair attached to the right moment arm is labeled 1b and is rotated on the end of the right moment arm by a motor and gear system labeled 2b. The angular momentum vector of a set of coaxial spinning gyroscopes is labeled +\vec{L} and −\vec{L} in FIG. 1a.

We know a spinning gyroscope has an angular momentum vector of

mR²ω_{S}\vec{a}_{ωs}=\vec{L} (I1)[1][2]

And, when \vec{L} is changed with respect to time a torque \vec{τ} is generated such as:

d\vec{L}/dt=\vec{τ}=d(mR²\vec{ω}_{S})/dt=mR²d\vec{ω}_{S}/dt (I2)[3]

For each gyroscope pair, the torque generated by turning the +\vec{L}, and −\vec{L}, vectors add.

For the gyroscopic orientation shown in the Drive Stroke (FIG. 1a), the direction of the angular momentum vector changes, even though all angular speeds remain constant, such that:

d\vec{ω}_{S}/dt=ω_{S}d(\vec{a}_{ωS})/dt=ω_{S}ω_{R}\vec{a}_{ωR} (I3)

And

mR²ω_{S}ω_{R}\vec{a}_{ωR}=\vec{τ}(where: W_{R}=forced angular velocity of rotation) (I4)

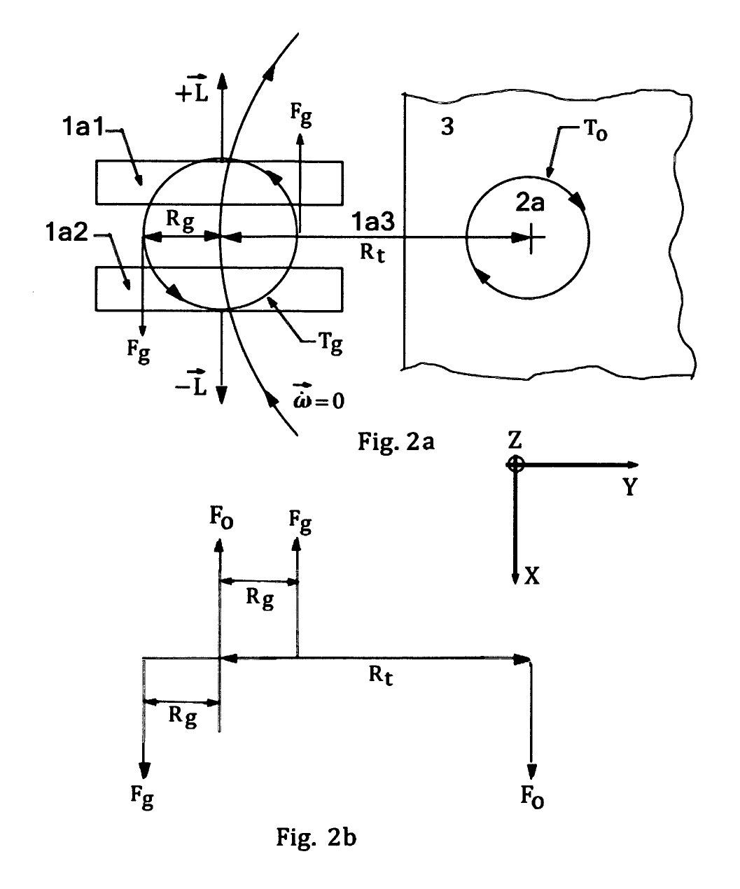

This torque must be provided by the motor and gear systems labeled 2a and 2b in FIGS. 1a, 1b, 2a.
B. Return Stroke (FIG. 1b)

For the Return Stroke the spin is zero so \vec{L}=0 and:

$$\frac{d \vec{L}}{d t} = \vec{τ} = 0 \qquad ( I 5 )$$

### C. Torque to Force

The torque produced in turning the gyroscopes (labeled 1a1 and 1a2 in FIG. 2a) is given in eq. (I4) above and must be provided by the motor and gear system labeled 2a. Considering the Left Arm System (1a),

Σ\vec{M}=0 (I6)

But, each motor and gear system supplying the torque and the gyroscope pair reacting the torque are separated by a moment arm R_{T} (labeled 1a3) so a force \vec{F}_{O} must be induced on the end of that moment arm such that:

P_{O}R_{T}=T_{R}(gyroscope reaction torque)=iₜ(motor input torque) (I7)

This force \vec{F}_{O} must be reacted with an equal and opposite \vec{F}_{O} exerted by each motor and gear system on the Housing (or Drive Vehicle) labeled 3 in FIGS. 1a, 1b and 2a. We begin by discussing the circumstances of

The forces and torques for an inertial lever arm terminated by a gyroscope must obey:

ΣF_{X}=0 (I8)

And:

ΣM_{Z}=0 (I9)

(The forces in Y and Z are always self cancelling by the symmetric construction technique of using two (2) counter-rotating sets of identical Drives.)

This relationship between system geometry and forces and torques can be interpreted in a lever arm equivalent diagram as shown in FIG. 2b where:

1a1=the front gyroscope and 1a2=rear gyroscope of gyroscope pair 1a.
1a3=Moment arm length R_{T}.
2a=Motor Gear System for Left Arm System.
F_{G}=Gyroscopic force opposing turning.
R_{G}=Distance between gyroscope spin axis and radius of gyration.
T_{G}=Gyroscope torque opposing turning.
T_{O}=Torque provided by motor gear system.
F_{R}=Force equivalent response to T_{O}.
T_{R}=Torque from motor gear system being reacted into Housing labeled 3.
The Right Arm System (1b) mirrors the Left Arm System and each adds thrust in the X direction.

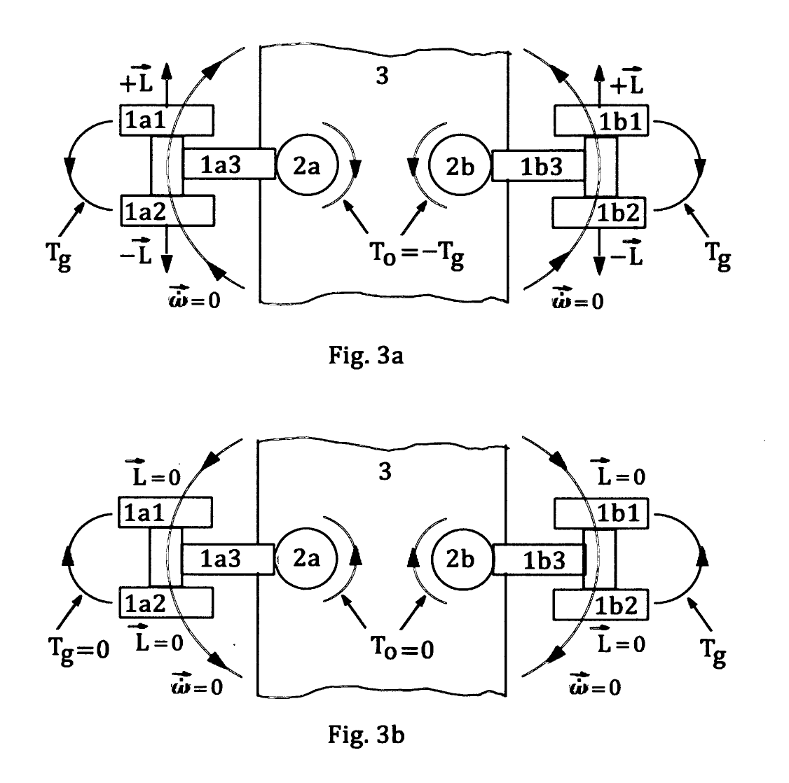

FIGS. 3a and 3b show the Drive Stroke and Return Stroke for both Moment Arm Systems 1a and 1b.

### Where:

1b1=the front gyroscope and 1b2=rear gyroscope of gyroscope pair lb.
1b3=Moment arm length R_{T}.
2b=Motor Gear System for Right Arm System.

And remaining construction and operation details of Right Moment Arm System replicate and mirror those of the Left Arm System. Similarly a lever arm equivalent diagram can be set up for the Right Moment Arm System that mirrors that shown in FIG. 2b.

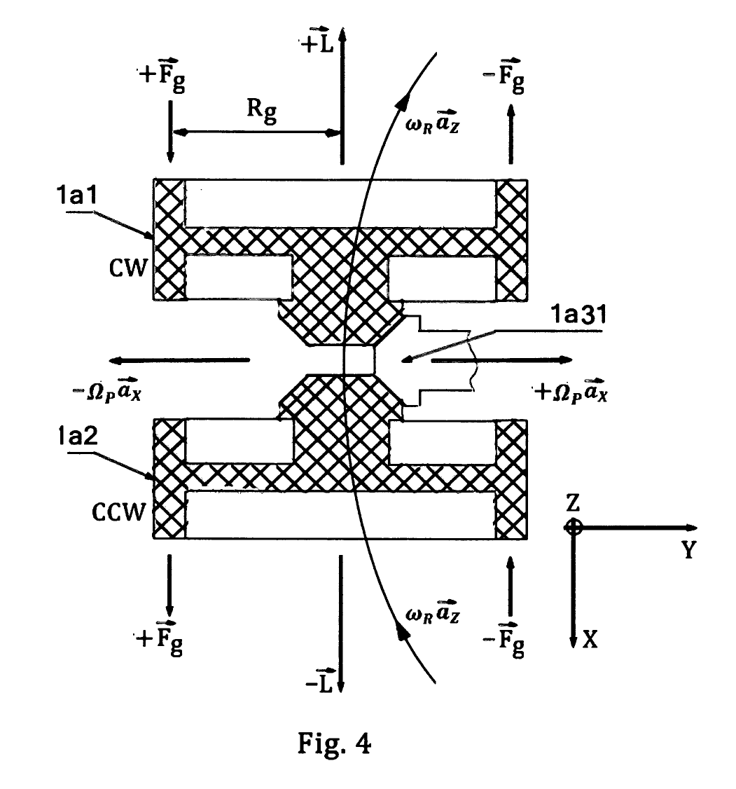

In FIG. 4 the advantages of mounting gyroscopes in back to back co-axial pairs can be seen. The co-axial pair arrangement with the gyroscopes spinning in equal and opposite angular velocities, allows the torque induced reactive forces to add while the precessions cancel. The arrangement also allows the moment arm to operate on the exact center of the spinning gyroscopes.

### II. GYROMOTOR EFFECT AS COMPARED TO ZERO-SUM

The concept of an action and reaction motor in which no plume is ejected is counter-intuitive and is considered by many to be impossible. These concerns will now be addressed. We begin by considering the Vehicle (labeled 3) as a Space Craft operating in earth orbit. Returning to FIGS. 1a, 1b, 2a, 2b, and 3, we note that the F_{O} produced by each Drive Motor on the Space Craft serves to “push off” against the Space Craft while F_{O} on the end of each moment arm “pushes off” against a separate inertial body (the spinning set of gyroscopes). So, we get a transfer of force and momentum to the Space Craft with respect to its external environment even as we see an equal and opposite transfer of force and momentum to the gyroscopes. An observer external to the Space Craft would see the Space Craft move in one direction and the gyroscopes move in the opposite direction according to conservation of momentum. The force produced by the gyroscopes rotating on the end of a moment arm acting over the Drive Stroke time has the dimensions of momentum and acts as a rocket plume with mass, velocity and momentum. The Space Craft would react equal and opposite to the gyroscope momentum. During the Return Stroke, gyroscope spin is off and the force produced by gyroscopes rotating on the end of a moment arm is zero. Thus, the momentum of the returning gyroscopes is zero and the Space Craft does not react. The Space Craft would experience a net momentum in the Direction of the Drive Stroke similar to rowing a boat. An observer inside the Space Craft would not notice a difference between the Drive and Return Strokes. In both strokes the Space Craft would seem to be stationary and the gyroscopes would move the same distance with respect to the Space Craft and at the same angular velocities. Newton's Laws seen by an observer inside the Space Craft-Gyroscope structure would seem unaffected (Zero-Sum), except for the force measured between gyro arms and Space Craft housing. To an observer outside the Space Craft, Newton's Laws would be satisfied by the Space Craft motion in reaction to the net reaction force between the gyro arms and the Space Craft housing. Newton's Laws would be obeyed but, they would be Zero-Sum in a different sense. The Space Craft would move with respect to the external observer. The speed of the gyro arms would appear slightly slower during the Drive Stroke and slightly faster during the Return Stroke. In this sense, the external observer would also see Zero-Sum. But, Space Craft motion would continue and that is what matters most.

### E. Governing Equations of Cycle Drive and Return Strokes.

Because a torque is added to the ends of the moment arm R_{T} during the Drive Stroke but, is absent during the Return Stroke, the net Drive Force remains to drive the Space Craft in return. This net drive force will now be determined.

Equal and opposite torque operating on opposite ends of a moment arm is mathematically equivalent to equal and opposite forces operating perpendicular to the moment arm such that:

\vec{τ}=\vec{F}X(R_{T})=F(R_{T}) sin θ\vec{a}_{X}+F(R_{T}) cos θ\vec{a}_{Y} (I10)

The Y components cancel each other and we are left with

$${F}_{X} = \frac{\vec{τ}}{{R}_{T}} sin θ \qquad ( I 11 )$$

\vec{τ} is constant when \vec{ω}_{R} and \vec{ω}_{S} are constant. When the Spin Axis is oriented in the direction of tangential instantaneous velocity the torque generated at each gyroscope is:

$$\vec{τ} = \frac{d \vec{L}}{d t} = I \frac{d {\vec{ω}}_{S}}{d t} = {mR}^{2} {ω}_{S} \frac{d {\vec{a}}_{ωS}}{d t} = {mR}^{2} {ω}_{S} {ω}_{R} {\vec{a}}_{ω R} \qquad ( I 12 )$$

R=R_{G} (gyroscope radius of gyration)
For a gyroscope set on the end of each of two (2) oars we have a torque of 2\vec{τ} and a linear force of:

$${F}_{X} = \frac{\vec{τ}}{{R}_{T}} sin θ = 2 m {\vec{\dot{V}}}_{X} = \frac{2 {mR}^{2} {ω}_{S} {ω}_{R} sin θ {\vec{a}}_{X}}{{R}_{T}} \qquad ( I 13 )$$

We know ∫ₜ₁^{t2}2m{dot over (\vec{V}_{Xdt=}2 mV_{X\vec{a}}_{X}(momentum in X) (I14)[4]

We also know:

$$d t = \frac{d θ}{{ω}_{R}} \qquad ( I 15 )$$

So:

$$\begin{matrix}{\int }_{θ 1}^{θ 2} \frac{2 {mR}^{2} {ω}_{S} {ω}_{R} sin θ}{{R}_{T}} ( \frac{d θ}{{ω}_{R}} ) = \frac{2 {mR}^{2} {ω}_{S} ( - cos θ2 + cos θ1 )}{{R}_{T}} \\ = 2 {mV}_{X}\end{matrix} \qquad ( I 16 )$$

With an X direction momentum from the Inertial Oars provided to the Boat of:

$$\frac{2 {mR}^{2} {ω}_{S} ( - cos θ2 + cos θ1 )}{{R}_{T}} = 2 {mV}_{X} ( for each cycle ) \qquad ( I 17 )$$

By conservation of momentum the Boat acquires an X direction velocity of

$${V}_{Boat} = {V}_{X} \frac{2 m}{{m}_{sc}} ( for the Drive Stroke of each cycle ) \qquad ( I 18 )$$

The Zero-Sum inertial stalemate has been broken by changing inertial mass properties and conditions have been created to drive a Space Craft using internal inertial means only.

### F. Back to Back Gyroscope Pairs

The gyroscopes are operated in back to back counter rotating pairs as per FIG. 4. This is done for several reasons. The Gyromotor requires the gyroscopes be operated with forced torque applied. This, in turn, means the individual gyroscopes seek to perform precession. The back to back arrangement, sharing the same spin axis and counter-rotating at the same angular speeds means that precession effects are self-cancelling and not a factor in Gyromotor performance. Also, construction and operation is simplified and form, fit, function is improved.

\vec{τ}=\vec{Ω}_{P}×\vec{L}_{G} (I19)[3][5]

### Where:

\vec{τ}=torque
\vec{Ω}_{P}=angular velocity of precession
\vec{L}_{G}=angular momentum of gyroscope

In FIG. 4 we see that when two (2) gyroscopes share a common spin center and counter-rotate back to back, their natural angular velocities of precession oppose each other and cancel.

Thus, in the back to back configuration net:

Σ\vec{Ω}_{P}=0. (I20)

The torque from gyroscope 1a1 and the torque from gyroscope 1a2 add. The bevel gear drive 1a31 causes the gyroscopes to counter-rotate at equal and opposite speeds. The forces generated by turning the gyroscopes acts at R_{G} as shown in FIG. 4.

### II. TOWARDS A PRACTICAL GYROMOTOR

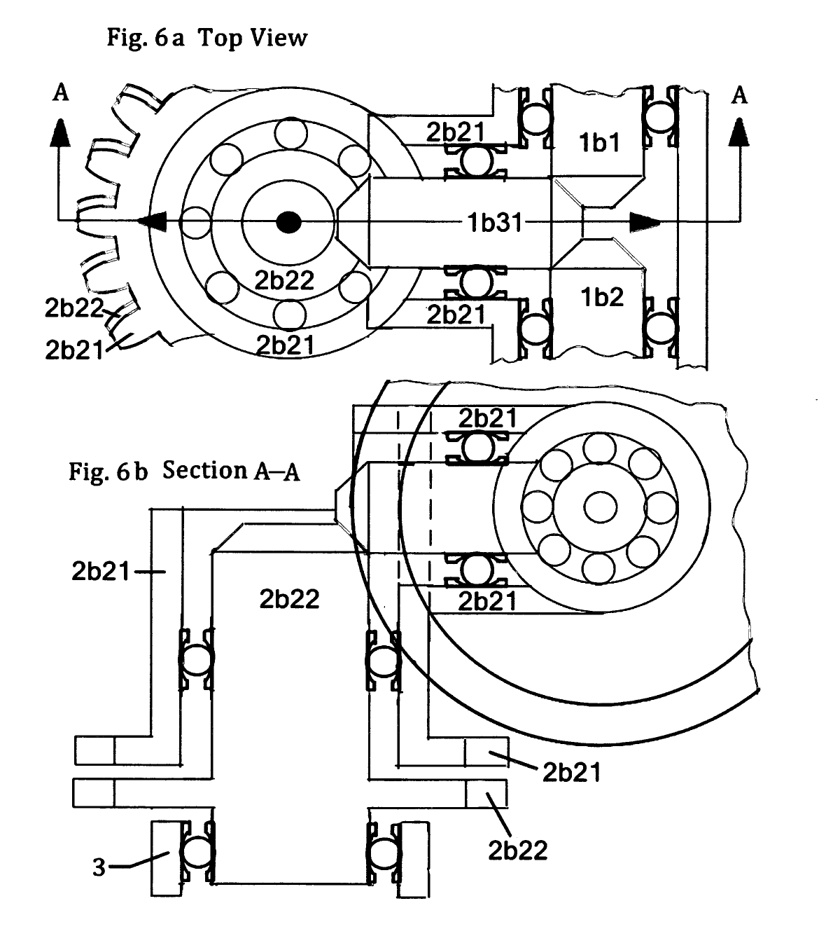

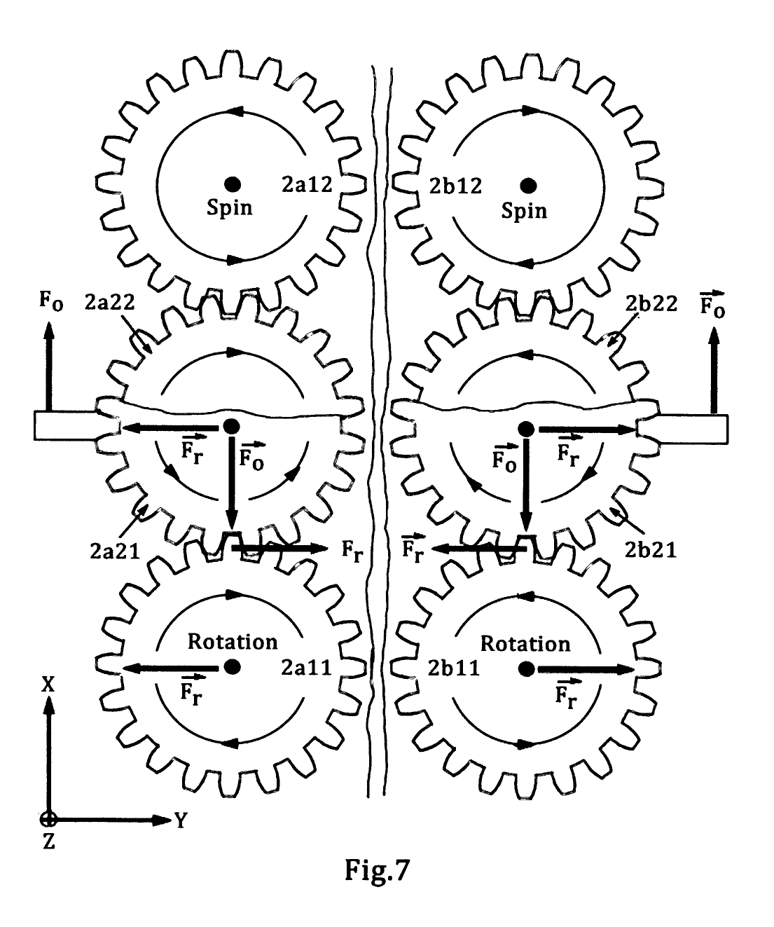

A Gyromotor can be constructed according to FIGS. 4, 5a, 5b, 6a, 6b its Drive Method can be applied according to FIGS. 3a, 3b. The construction methods shown in FIGS. 6a, 6b, 7 enable the gyroscopes and moment arm to be cycled while the electric motors that power them remain stationary in the Space Craft housing. This reduces un-sprung weight, enables faster cycle times and eliminates the danger of failure from electrical cable and connection problems. These motors are operated in pairs to operate a single moment arm and pair of gyroscopes. This arrangement enables the gyroscopes to be spun up or spun down independent of moment arm rotation. The gyroscopes on the end of each moment arm are positioned and operated in counter-rotating pairs, sharing the same spin axis according to FIG. 4. This cancels out gyroscope precession and simplifies construction.

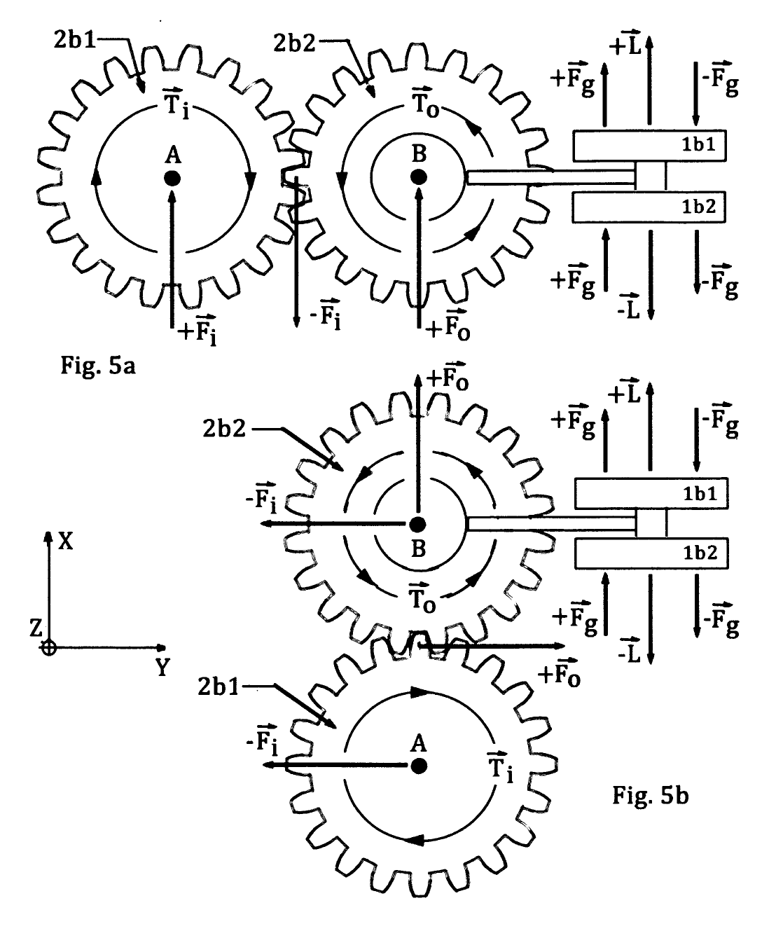

A construction method is illustrated in FIGS. 5a, 5b, 6a, 6b and 7. FIGS. 5a and 5b show alternate arrangements in which electric motors, that drive the Gyromotor arms, can be located in the Space Craft housing and can drive the gyroscope mechanisms through gearing without disturbing the force and torque balance needed to drive the Space Craft with reaction forces. All the example positions as per FIGS. 5a and 5b, leave a reaction force operating on the Space Craft. This is because one force of a chain of forces and reaction forces reacts against gyroscope inertia separate from the Space Craft structure. This uncovers and isolates an equal and opposite force which operates on the Space Craft housing. FIG. 6, shows a mechanical structure which can transform the forces into the appropriate gyroscope and arm motions. FIG. 7 shows how the features shown in FIGS. 5a, 5b and 6 work together as a Gyromotor drive system.

We choose one (1) 4490 . . . B Micromo dc servo motor, 11,000 rpm, 390.533 oz-in. stall torque, with a gear box of 40/1 to perform the Drive and Stroke rotation. This provides:

$$( 390.553 oz \cdot in \cdot 40 ) / ( 16 \frac{oz}{lb} \cdot 12 \frac{in}{ft} ) = 81.3610416666667 ft \cdot lbs ( torque ) \qquad ( II 1 ) [ 6 ]$$

At a speed of:

$$\begin{matrix}\frac{11 , 000 ( \frac{rev}{min} ) \cdot 2 π ( \frac{rad}{rev} )}{( 40 \cdot 60 ( \frac{sec}{min} ) )} = {ω}_{R} ( \frac{rad}{sec} ) ( available rotation speed ) \\ = 28.7979326579064 \frac{rad}{sec}\end{matrix} \qquad ( II 2 )$$

We stay with the same motor for gyroscope spin up and spin down and reserve judgment on the gear box for the moment.

We select gyroscopes with flywheels of 0.5 ft radius, weighing 5 lbs and spinning at 600 rpm=20π rad/sec. We select a moment arm of 0.75 ft. and rotate it at 15 (rad/sec).

600 rpm means #4490 . . . B can support a spin up MA of:

$$\frac{11 , 000 rpm}{600 rpm} = 18.3333333333333 = MA \qquad ( II 3 )$$

We use 15=MA to be conservative.

$$\frac{390.533}{16 \cdot 12} \cdot 15 = 30.510390625 ft \cdot lb ( available spin up torque from electric motor \& gear box )$$

This Spin up torque provides a spin up angular acceleration (d\vec{ω}_{S}/dt) as per:

$$\begin{matrix}\begin{matrix}\vec{τ} = {mR}^{2} \frac{d {\vec{ω}}_{S}}{d t} \\ = \frac{5 lb}{32.2 ( ft / {sec}^{2} )} {( 0.5 ft )}^{2} \frac{d {\vec{ω}}_{S}}{d t} \\ = 30.510390625 ft \cdot lb\end{matrix} & ( II4 ) \\ \begin{matrix}\frac{d {\vec{ω}}_{S}}{d t} = 128.8 \frac{ft}{{sec}^{2}} \cdot \frac{30.510390625 ft \cdot lbs}{5 lbs} \\ = 785.9476625 \frac{rad}{{sec}^{2}}\end{matrix} & ( II 5 )\end{matrix}$$

Which requires a time from zero to 600 rpm of:

$$\frac{20 π ( rad / sec )}{785.9476625 ( rad / {sec}^{2} )} = t = 0.0799440676138 sec \qquad ( II 6 )$$

With the knowledge our motor gear box combinations can meet our arbitrary design requirements, we calculate an estimated performance.

$$\frac{2 {mR}^{2} {ω}_{S} ( - cos θ 2 + cos θ 1 )}{LT} = 2 {mV}_{X} ( for each cycle ) \qquad ( I 16 )$$

We estimate that start up from rest to full rotation speed takes (π/4)rad as does slow down from full rotation speed to stop. We also choose LT=0.75 ft and, conservatively say 1 cycle per second can be performed. Thus we have:

$$\frac{2 \cdot ( \frac{5}{32.2} ) \cdot {( 0.5 )}^{2} \cdot 20 π \cdot ( \frac{2}{\sqrt{2}} )}{0.75} = 2 {mV}_{X} ( lb \cdot sec ) ( per cycle ) \qquad ( II 7 )$$

### And:

$$\frac{27.5955461997414}{0.75} = 36.7940615996552 lb \cdot \frac{sec}{sec} \\ ( momentum transfer rate ) \qquad ( II 8 )$$

This means our 10 lbs of gyroscope rest mass (2 arms with 5 lbs of gyroscopes each) would acquire a speed increase on a per cycle basis of:

$$\frac{36.7940615996552 lb \cdot sec}{10 lb} \cdot 32.2 \frac{ft}{{sec}^{2}} = 118.47687835089 ft / sec ( for a 10 lb payload ) \qquad ( II 9 )$$

For a 2,000 lb space craft this equates to:

$$\frac{10 lb}{2 , 000 lb} \cdot 118.47687835089 \frac{ft}{sec} = 0.5923843917545 \frac{ft}{sec} \\ ( for a single cycle ) \qquad ( II 10 )$$

With a cycle rate of one (1) cycle per second, within 20 sec the 2,000 lb object will acquire a speed of 11.84768783509 ft/sec. These speed values are encouraging.

### III. PROTOTYPE ESTIMATED PERFORMANCE AND FORM, FIT, FUNCTION

0.75 ft moment arm
0.5 ft radius of gyration
1.25 ft radius for gyro ring mounted on a moment arm=2.5 ft dia foot print.
[5 ft diameter for two (2) Drivers]
[Height >1.5 ft+Electric Motor]
5 lb gyro ring weight
Micromo Brushless DC Servomotor 4490 . . . B, 1.732 in. dia, 3.543 in. length wt 750 g [750 grams=1.65346696638658 lbs. If we double the size to include the gear box, we get approx 6.5 lbs of motor and gear box weight for one (1) Drive Arm system and approximately 13 lbs. for the entire system.]

These are rough estimates but, the values are encouraging especially for a motor to drive a Space Craft of 2,000 lbs.

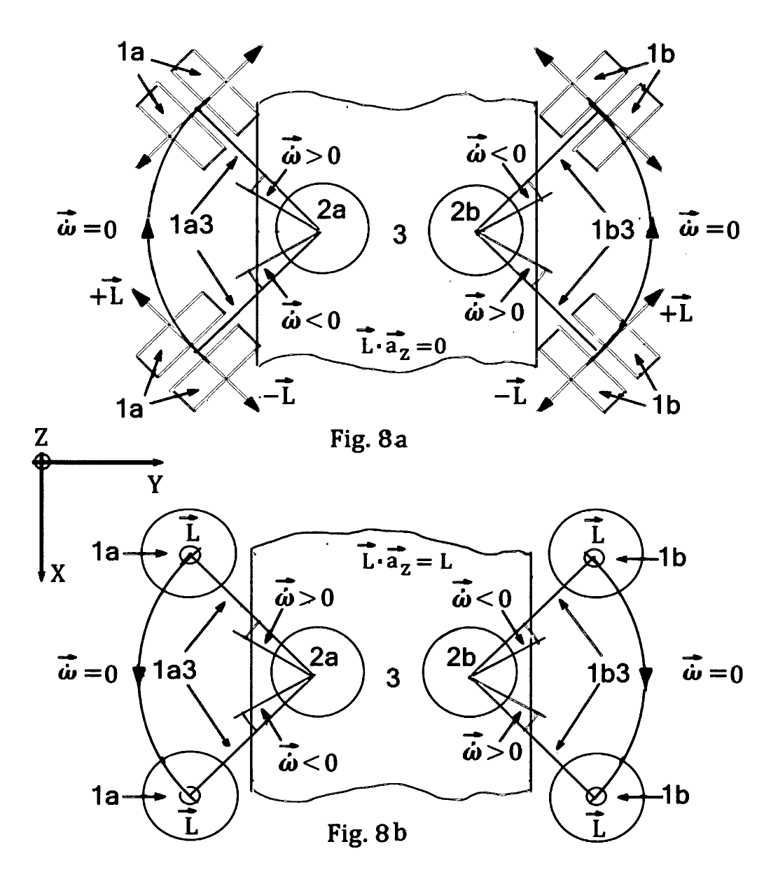

### IV. AN ALTERNATE DRIVE METHOD (FIGS. 8a, 8b, 9a, 9b, 10a, 10b, 11)

The Return Stroke can also produce zero torque if the gyroscope spin axis vectors do not change direction during the return stroke as shown in FIG. 8b. In this instance (d\vec{a}_{ωS}/dt)=0 so:

$$\vec{τ} = \frac{d \vec{L}}{d t} = I \frac{d {\vec{ω}}_{S}}{d t} = {mR}^{2} {ω}_{S} \frac{d {\vec{a}}_{ω S}}{d t} = 0 ( because \frac{d {\vec{a}}_{ω S}}{d t} = 0 ) \qquad ( IV 1 )$$

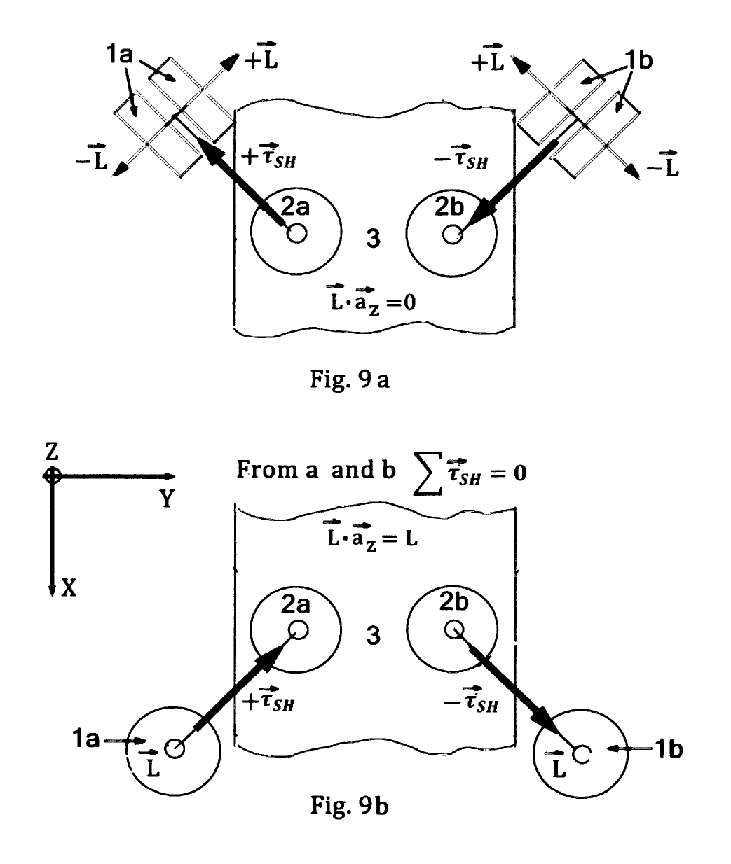

This leaves the problem of switching the orientation of the gyroscopes at the end of the Return Stroke so torque can be generated during the Drive Stroke and switching gyroscope orientation again before the Return Stroke. Each orientation switch produces a torque as shown in FIG. 9a. But, as also shown in FIG. 9b, the orientation switches can be performed so as make the switching torques self-cancelling as per:

Σ\vec{τ}_{SH}=0 (IV2)

The orientation switching method appears a viable alternative to spinning down and spinning up the gyroscopes.

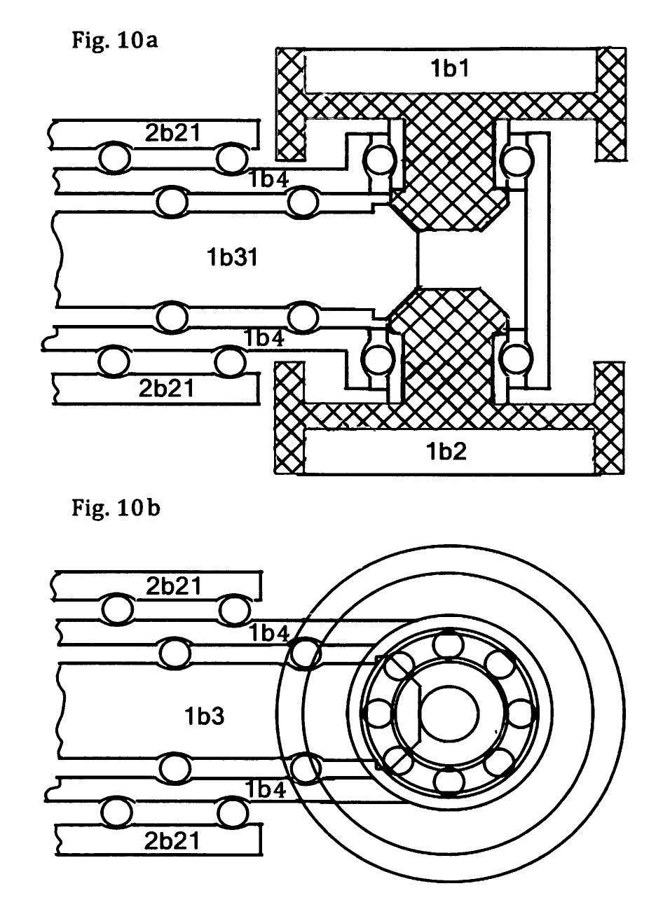

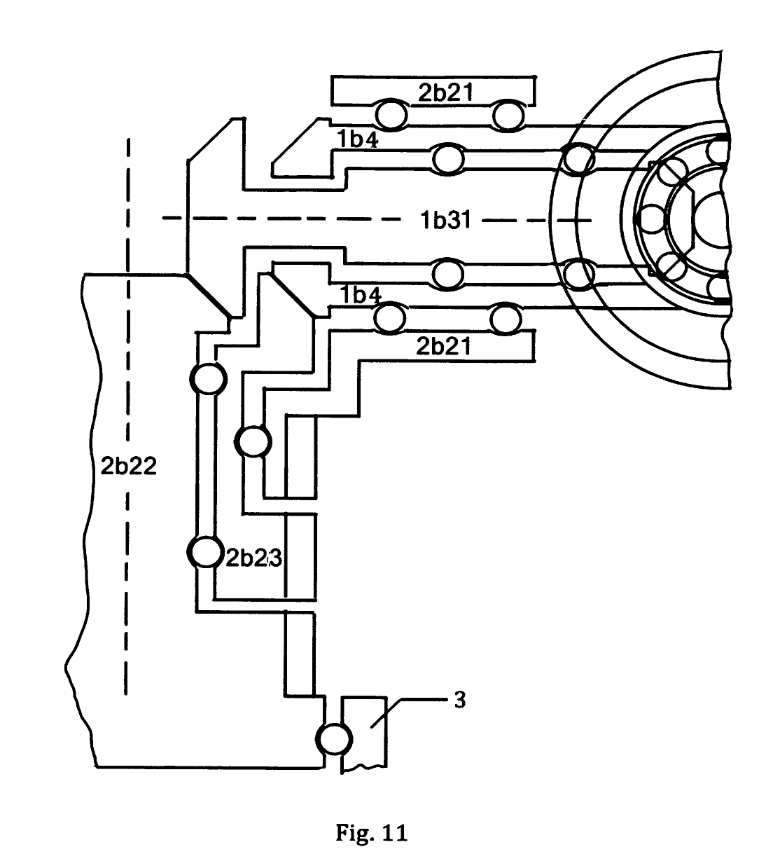

FIGS. 10a, 10b, 11 illustrate a mechanical arrangement capable of performing the Alternate Drive Method. This arrangement is an extension of the arrangement shown in FIGS. 6a, 6b and 7 in which an additional co-axial geared shaft system is added (2b23 and 1b4 in FIG. 11) and an additional set of bearings is added to enable 1b4 to rotate inside 2b21. A third Motor and Gear System per gyroscope pair is also required along with added capability for the control system.

### V. SUMMARY AND CONCLUSIONS

1. The Gyromotor concept appears to work. It seems possible to generate useful reaction thrust from a motor that performs an internal cycle to generate external thrust and/or force and that uses renewable energy. It seems possible to do so by changing the inertial properties of parts internal to the motor while leaving the rest mass of each unchanged. This, in turn, seems possible to accomplish by using gyroscopes in novel ways. Newton's Laws of Motion seem not to be violated.
2. The construction of a practical Gyromotor seems straight forward and well within current art.
3. The performance and thrust to weight of a Gyromotor seems useful for applications in micro-gravity, such as low earth orbit and space beyond. The form, fit, function factors also seem favorable. The thrust to weight is not sufficient to provide lift-off against earth gravity.
4. Gyromotor presents an important opportunity to further performing useful work in low earth orbit and space beyond and this Gyromotor paper establishes a preliminary and tenuous level of credibility.
5. The technical community needs to prove out the concept up or down. They could start with a credible simulation and from there move to hardware and developments as results determine.

What is claimed is:

1. A method for generating and applying pseudo inertial forces and torques within an apparatus whereby said apparatus can move itself and an attached object with respect to a distant object;
whereby, said movement can be in translation or rotation or in combinations of rotation and translation;
whereby said pseudo forces are generated by means of rotating each of two (2) or more moment arms in a coordinated back and forth rowing motion with each said moment arm attached to a shared housing on one end and to a non-shared gyroscope apparatus on the other;
whereby said moment arms are arranged in one (1) or more pairs symmetric to a chosen direction of translation; whereby, said rotation is constrained to a single plane;
whereby, each Drive Stroke is performed with each said gyroscope spinning with spin axis pointing in direction of its' instantaneous tangential velocity and each Return Stroke is performed with each said gyroscope not spinning with spin axis pointing in direction of its' instantaneous tangential velocity; whereby, inertial pseudo force and torque is generated during each said Drive Stroke and is not generated during each said Return Stroke; whereby, not generating torque during said Return Stroke can be accomplished either by removing spin in said gyroscopes prior to Return Stroke or in pointing each said gyroscope spin axis parallel to its' axis of rotation (and said Moment Arm axis of rotation) prior to said Return Stroke;
whereby, said translation inertial pseudo force is generated by symmetrically counter-rotating said aims in the direction of translation by performing said Drive and Return Strokes and the direction of translation is reversed by reversing the rotation direction of said Drive and Return Strokes;
whereby, said pseudo force and torque components in directions other than said direction of translation cancel each other;
whereby, said rotation inertial pseudo torque is generated by rotating each arm in the same angular direction during said back and forth rowing motion while performing said Drive and Return Strokes and direction of rotation is reversed by reversing the direction of said Drive and Return Strokes;
whereby, said pseudo force and translation components in directions other than said direction of rotation cancel each other;
whereby, said translation is generated in any chosen direction in the plane of said moment arm pair by rotating said moment arm shared housing to point in said chosen direction, followed by performing said translation, thereafter performing rotation to desired angular orientation;
whereby, said moment arm plane of rotation and said shared housing operating plane can be changed in angular orientation by generating inertial pseudo torque about said moment arms while said moment arms remain directly opposite each other;
whereby, said inertial torque is generated by rotating both said gyroscopes in the same angular direction (Twist) under conditions of gyroscope spin and is reduced to zero under conditions of no spin return (Twist Return); whereby, angular direction of said Twist and said Twist Return determine angular direction of said moment arm plane of rotation and angular direction of said shared Housing operating plane;
whereby, said Twist and Twist Return steps can be repeated with cumulative effect; and
whereas, the aggregate effect of pseudo force and pseudo torque selective generation and control is to enable said gyroscope system arms and said shared housing and attached payload to move and position itself in a volume.

2. An apparatus for performing said method according to claim 1 comprising: a) A Moment Arm System, b) A Gear Motor Drive System, c) A Controller, d) A Vehicle Housing wherein said Apparatus of Moment Arms, Gear Motor Drive System and Controller are contained and said Payload is attached.

3. A Moment Arm System apparatus according to claim 2 comprising: a) A Moment Arm Gear and Bearing system and b) A Gyroscope apparatus, wherein a said Gyroscope apparatus is positioned on the end of each said Moment Arm Gear and Bearing system displaced from said Moment Arm Gear and Bearing system center of rotation, wherein rotation is performed by input to a first gear and gyroscope wheel spin is performed by input to a second gear, wherein said rotation is about a fixed point on said Vehicle Housing, wherein said motion other than said rotation and said spin is constrained with respect to said Vehicle Housing, wherein said rotation and said spin are independent of each other.

4. A Gyroscope apparatus according to claim 3 comprising: two (2) identical, co-axial gyroscopes, whereby said gyroscopes counter-rotate at equal and opposite speeds, whereby said gyroscopes have variable spin rates, whereby the center of rotation for each gyroscope wheel is equidistant from said Moment Arm Gear and Bearing System center of rotation, whereby said co-axial spin axis is in the direction of rotation instantaneous tangential velocity.

5. A Moment Arm System apparatus according to claim 4, whereby said Gyroscope apparatus is rotated back and forth in a single plane with said spin axis aligned with rotation instantaneous tangential velocity during both said Drive Stroke and said Return Stroke and whereby Gyroscope spin is present during said Drive Stroke and absent during said Return Stroke.

6. A Gear Motor Drive System according to claim 5, wherein each said Moment Arm System apparatus function is performed by a separate Gear Motor fixed to said Vehicle Housing, whereby each said Moment Arm Gear and Bearing system is rotated by a dedicated Gear Motor and each said Gyroscope Apparatus is operated in spin by a dedicated Gear Motor.

7. A controller according to claim 6, comprising: a) A Micro-Controller, b) Electric Power Supply, c) Electric Power Switching System, d) Sensing System, whereby said Gear Motor Drive System components can be selectively energized and interactively controlled on an independent basis.

8. A Moment Arm System apparatus according to claim 6, whereby a first Gear Motor fixed to said Vehicle Housing can spin a pair of gyroscope wheels displaced from said Moment Arm System center of rotation and a second Gear Motor, fixed to said Vehicle Housing, can rotate said gyroscope wheels about said center of rotation, wherein said spin direction and said direction of tangential instantaneous velocity are aligned for said gyroscope wheels, wherein said wheels counter-spin with a shared spin axis and whereby said rotation and said spin can be performed independent of each other comprising: 1) a Spin Drive Shaft system, 2) a Rotation system and 3) a Moment Arm System Housing, whereby said Spin Drive Shaft system transfers mechanical power from a said stationary first Gear Motor to spin said gyroscope wheels, whereby said Rotation system houses and positions said gyroscope wheels and said Spin Drive System components therein and transfers mechanical power from a stationary second Gear Motor to rotate said gyroscope wheels and said Spin Drive Shaft components about said Moment Arm System center of rotation, whereby said Spin Drive Shaft components and said Rotation system are coupled together to form a Moment Arm System Housing, whereby said Moment Arm System Housing is coupled to said Vehicle Housing to provide a functional Moment Arm system apparatus;
said Spin Drive Shaft system comprising: a Spin Drive Shaft Idler and a Spin Drive shaft, whereby mechanical power is received by said Spin Drive Idler, causing it to rotate co-axial with said Moment Arm system center of rotation, where after said mechanical power is transferred to said Spin Drive Shaft with direction of spin changed a first time, where after said mechanical power is transferred to each of two said identical co-axial gyroscope wheels with direction changed a second time, causing said wheels to counter-spin with spin direction of each said wheel aligned with direction of said wheel rotation instantaneous tangential velocity;
said Moment Arm Structure, comprising a Rotation Shaft portion, a Moment Arm portion and a Wheel House portion, where said portions are of a single structure, wherein said Rotation Shaft portion has an external gear co-axial with an internal bearing surface, wherein said Moment Arm portion has an internal bearing surface with rotation axis orthogonal to and intersecting with said Rotation Shaft portion rotation axis, wherein said Wheel House portion has two co-axial bearing surfaces orthogonal to and intersecting said Moment Arm portion internal bearing surface, whereby said Spin Drive Shaft Idler is housed in said Rotation Shaft portion, whereby said Spin Shaft Drive is housed in said Moment Arm portion, whereby Gyroscope Wheels are housed in said Wheel House portion, whereby mechanical power is received by said Rotation Shaft portion external gear causing said Moment Arm Structure to rotate co-axial with and independent of said Spin Drive Shaft Idler rotation, whereby said Spin Drive Shaft and said Gyroscope Wheels rotate with said Moment Arm Structure, whereby said Gyroscope Wheel spin is independent of said rotation; and
said Moment Arm System Housing, comprising said Spin Drive Shaft Idler, said Moment Arm Structure, said Vehicle Housing and said low friction rolling bearing interfaces whereby said Spin Drive Shaft Idler is coupled to said Vehicle Housing, whereby said Spin Drive Shaft Idler is coupled to said Moment Arm Structure and, whereby said Moment Arm Structure is indirectly coupled to said Vehicle Housing, whereby said Vehicle Housing functions as mechanical ground.

9. A Moment Arm Structure according to claim 8, wherein distance between said rotation axis of said Rotation Shaft portion and shared spin axis of said Wheel House portion, determines the moment arm length of said rotating, counter-spinning co-axial Gyroscope Wheels.

10. A Moment Arm Structure according to claim 9, whereby said Spin Shaft Drive Idler is coupled to said Rotation Shaft portion inner bearing surface with low friction rolling bearings, whereby said Spin Shaft Drive Idler and said Moment Arm Structure can rotate independent of each other, said low friction rolling bearings whereby movement along said axis of rotation is constrained and tipping about said axis of rotation is constrained, whereby said Spin Drive Idler is located with respect to said Moment Arm Structure with precision sufficient to provide satisfactory mesh for geared interfaces on both ends of said Spin Shaft Drive Idler.

11. A Moment Arm Structure according to claim 10, whereby said Spin Shaft Drive is coupled to said Moment Arm portion inner bearing surface with low friction rolling bearings, whereby said Spin Drive Shaft and said Moment Arm Structure can rotate independent of each other, said low friction bearings whereby movement along said axis of rotation is constrained and tipping about said axis of rotation is constrained, whereby said Spin Drive Shaft is located with respect to said Moment Arm Structure with precision sufficient to provide satisfactory mesh with said Spin Drive Shaft Idler and said Gyroscope Wheels.

12. A Moment Arm Structure according to claim 11, whereby each of two said Gyroscope Wheels is coupled to said Wheel Housing portion by low friction, rolling bearings, whereby each said Gyroscope Wheel can spin independent of said Moment Arm Structure movement, whereby movement along each said axis is constrained and tipping about each said axis is constrained, whereby said Gyroscope Wheels are each located co-axial with precision sufficient to provide satisfactory mesh with said Spin Drive Shaft.

13. A Moment Arm System Housing according to claim 12, wherein said Moment Arm Structure is coupled to said Spin Drive Shaft Idler with low friction rolling bearings and said Spin Drive Shaft Idler is coupled to said Vehicle Housing with low friction rolling bearings, whereby said Spin Drive Shaft Idler is free to rotate co-axial with said Moment Arm center of rotation, whereby said Moment Arm System Housing is free to rotate about said Moment Arm center of rotation and said Gyroscope Wheels are free to rotation about said Moment Arm center of rotation, whereby Gyroscope Wheel spin is independent of said Gyroscope Wheel rotation, whereby said low friction rolling bearings constrain movement of said Spin Drive Axis and said Moment Arm System Housing along said axis of rotation and constrain tilt with respect to said axis of rotation.

14. A Moment Arm System apparatus, according to claim 6, whereby a first Gear Motor fixed to said Vehicle Housing can spin a pair off co-axial Gyroscope Wheels displaced from said moment arm center of rotation, whereby a second Gear Motor fixed to said Vehicle Housing can change the spin axis direction of said Gyroscope Wheels and whereby a third Gear Motor fixed to said Vehicle Housing can rotate said Gyroscope Wheels about said moment arm center of rotation, whereby said Gyroscope Wheel spin, said Gyroscope Wheel rotation and said Gyroscope Wheel spin change in direction can each be performed independent of the others comprising:
1) A Spin Drive Shaft system, 2) A Spin Direction Change System 3) A Gyroscope Wheel Rotation system, whereby Gyroscope Wheel spin, Gyroscope Wheel rotation and Gyroscope Wheel spin direction change can be performed independently;
said Spin Drive Shaft system comprising: a Spin Drive Shaft Idler, a Spin Drive Shaft and a pair of co-axial, counter-spinning Gyroscope Wheels, wherein said Spin Drive Shaft Idler is coupled to said Vehicle Housing free to rotate in direction of said Gyroscope Wheel rotation, wherein said Spin Drive Shaft Idler is bevel gear meshed with said Spin Drive Shaft so as to affect power transfer and to change direction of mechanical power by 90 deg., wherein said Spin Drive Shaft is bevel gear meshed with said first and second Gyroscope Wheels so as to spin said Gyroscope Wheels in equal and opposite spin directions and to change direction of said spin axis by 90 deg from that of said Spin Drive Shaft, wherein whereby mechanical power from a said first Gear Motor is received by said Spin Drive Shaft Idler causing said Spin Drive Shaft Idler to spin, whereas said Drive Shaft Idler spin, causes said Spin Drive Shaft to spin with spin axis changed by 90 deg, whereas said Spin Drive Shaft spin causes said first and said second Gyroscope Wheels to counter-spin about a common spin axis, whereby said common spin axis is 90 deg. to said Spin Drive Shaft and whereby said common spin axis direction can be at any angle in a plane 90 deg with respect Spin Drive Shaft including alignment with said Gyroscope Wheel instantaneous tangential velocity due to rotation (whereby maximum torque is generated) and parallel with said axis of rotation (whereby minimum torque is generated);
said Spin Direction Change system comprising: A Spin Axis Shift Shaft Idler, A Spin Axis Shift Shaft, A Wheel Housing on End of Spin Axis Shift Shaft, wherein said Shift Shaft Idler is co-axial with said Spin Axis Shift Shaft Idler and bevel gear meshes with said Spin Axis Shift Shaft with said Wheel Housing and Gyroscope Wheels attached thereto,
wherein said Spin Axis Shift Shaft is coaxial with said Spin Axis Drive Shaft;
wherein said Spin Direction Change system whereby mechanical power applied to said Spin Axis Shift Shaft Idler, is transferred to said Spin Axis Shift Shaft with axis of rotation changed 90 deg, from being aligned with said axis of Gyroscope rotation;
whereby said Spin Axis Shift Shaft rotation rotates said Gyroscope Spin Axis as well;
whereby said Gyroscope Wheel spin axis can be aligned with said rotation instantaneous tangential velocity vector (with maximum reaction torque) or aligned with said rotation vector (with minimal reaction torque) or aligned positioned anywhere between;
whereby said sin axis shift can be performed independent of said Gyroscope Wheel spin and said Gyroscope Wheel rotation by means of a stationary said Gear Motor;
said Gyroscope Wheel Rotation system comprising: A Rotation Shaft Idler, a said Spin Drive Shaft Idler and a said Spin Axis Shift Shaft with Wheel Housing and Gyroscope Wheels attached thereto;
whereby mechanical power, from a said stationary Gear Motor, applied to said Rotation Shaft Idler, rotates said Rotation Shaft Idler around said Spin Drive Shaft Idler and rotates said Spin Axis Shift Shaft with said Wheel Housing and Gyroscope Wheels attached thereto; and
wherein, said Gyroscope Wheel spin and said spin axis change can be performed independent of said rotation.

15. A Spin Drive Idler, according to claim 14 comprising a first bearing portion on one end, an external gear portion adjacent to said first bearing portion, a second bearing portion adjacent to said external gear portion and an external beveled gear portion adjacent to said second bearing portion, whereby said Spin Drive Idler is coupled to said Vehicle Housing by said first bearing portion.

16. A Spin Drive Shaft Idler, according to claim 15, coupled to said Vehicle Housing with low friction rolling bearings, whereby rotation is free and independent about said center of rotation, in said direction of said Gyroscope Wheel rotation and constrained against movement in other directions, whereby said external gear portion is meshed with said first Gear Motor, whereby said Spin Drive Shaft Idler is coupled to said Rotation Shift Shaft Idler with low friction, rolling bearings, whereby said rotation is free and independent about said center of rotation and is constrained against movement in other directions, whereby said external beveled gear is meshed with said external beveled gear of said Spin Drive Shaft.

17. A Spin Drive Shaft, according to claim 16, comprising a first external beveled gear, a shaft and a second external beveled gear, whereby said first beveled gear meshes with said Spin Drive Shaft Idler beveled gear, whereby said shaft is coupled co-axial to said Spin Axis Shift Shaft with low friction rolling bearings, whereby said Spin Drive rotation is free and independent in a direction 90 deg to said center of rotation axis vector and 90 deg to said instantaneous tangential velocity vector, but is constrained against movement in other directions, whereby said second beveled gear meshes with beveled gears of said Gyroscope Wheels.

18. A Gyroscope Wheels according to claim 17, comprising two identical counter-spinning wheel structures, each with a Wheel, a bearing surface and an external beveled gear, with said wheel structures spinning about a common spin axis and driven by a single said beveled gear from said Spin Drive Shaft, whereby each said Gyroscope Wheel is coupled over its bearing surface to said Spin Axis Shift Shaft Wheel Housing with low friction rolling bearings whereby each said wheel structure can rotate free and independent in direction of said spin axis but, is constrained against movement in other directions, whereby said spin axis vector is 90 deg to said rotation axis vector, in said plane of said rotation instantaneous tangential velocity.

19. A Spin Axis Shift Shaft, according to claim 18, comprising a said first external bevel gear, an adjacent set of co-axial internal and external bearing surfaces, a said Wheel Housing with said Gyroscope Wheel structures and bearings attached thereto, whereby, said firs external beveled gear meshes with said Spin Axis Shift Shaft Idler, whereby said internal bearing surface couples said Spin Axis Shift Shaft with said Spin Drive Shaft, whereby said external bearing surface couples said Spin Axis Shift Shaft with said Rotation Shaft Idler, whereby said bearing couplings use low friction, rolling bearings, whereby rotation about said Spin Drive Shaft Axis is free and independent, whereby movement in other directions is constrained.

20. A Spin Axis Shift Idler, according to claim 19, comprising a first external gear, an inner bearing surface co-axial with an outer bearing surface and an external beveled gear, whereby said Spin Axis Shift Idler is coupled co-axial to said Spin Drive Shaft Idler over said inner bearing surface and is coupled co-axial with said Rotation Shaft Idler over said outer bearing surface, whereby each said bearing coupling uses low friction, rolling bearings whereby rotation, free and independent is permitted about said axis of moment arm rotation, but movement in other directions is constrained, whereby said first external gear meshes with said second stationary Gear Motor and said external bevel gear, meshes with said bevel gear of said Spin Axis Shift Shaft.

21. A Rotation Shaft Idler, according to claim 20, comprising an external gear, a first internal bearing surface co-axial with said external gear, said Spin Axis Shift Shaft Idler and said Spin Drive Shaft Idler and a second internal bearing surface at 90 deg to said internal bearing, co-axial with said Spin Drive Shaft and said Spin Axis Shift Shaft, whereby said first internal bearing surface is coupled co-axial to a said external bearing surface on said Spin Axis Shift Shaft Idler and said second internal bearing surface is coupled co-axial to said external bearing surface on said Spin Axis Shift Shaft, whereby each said coupling uses low friction rolling bearings, whereby said Rotation Shaft Idler is free to rotate about said center of rotation axis and constrained against movement in other directions, whereby said rotation is independent of said rotation of said Spin Drive Shaft Idler and said Spin Axis Shift Idler, whereby said Rotation Shaft Idler takes said Spin Axis Shift Idler with said Wheel House and said Gyroscope Wheels attached thereto and said Spin Drive Shaft with it when it rotates, whereby said Gyroscope Wheel counter-spin and said Spin Axis shift can be operated independent of said rotation.

22. A Moment Arm apparatus, according to claim 21, whereby said Gyroscope wheel spin and said counter-spin axis direction can be changed independent of rotation, whereby said counter-spin axis orientations available include alignment with said rotation instantaneous tangential velocity, whereas reaction torque is maximum, and alignment with said axis of rotation, whereas said reaction torque is minimum, whereby said reaction torque can be varied and controlled by varying said alignment.
